(19) United States
(12) Patent Application Publication
(10) Pub. No.: US 2022/0198533 A1
(43) Pub. Date: Jun. 23, 2022

(54) GRANULAR RATING SYSTEM

(71) Applicant: Menu, Inc., Victor, NY (US)

(72) Inventor: Omar Qureshi, Victor, NY (US)

(21) Appl. No.: 17/550,610

(22) Filed: Dec. 14, 2021

Related U.S. Application Data
(60) Provisional application No. 63/127,075, filed on Dec. 17, 2020.

(51) Int. Cl. G06Q 30/02; G06F 16/901; G06F 16/9537

(52) U.S. Cl. CPC G06Q 30/0282; G06F 16/9537; G06F 16/9027

(57) ABSTRACT

A system for providing a granular rating of an item is described. The system identifies an item stored in a data structure. The system identifies a granular item of the item based on a tree structure of the item in the data structure. The system identifies an attribute of the granular item. The system receives a value of the attribute of the granular item and stores the value of the attribute of the granular item in the tree structure of the item in the data structure.

### RELATED APPLICATION

The present application claims priority to U.S. Provisional Patent Application Ser. No. 63/127,075, filed Dec. 17, 2020, which is hereby incorporated by reference in its entirety.

### TECHNICAL FIELD

The subject matter disclosed herein generally relates to a special-purpose machine that generates a granular rating for items, including computerized variants of such special-purpose machines and improvements to such variants. Specifically, the present disclosure addresses systems and methods for identifying a granular level of an item, accessing user-generated content for the granular level, analyzing the user-generated content, generating a rating based on the user-generated content, and providing search functionalities related to the rating, the granular level of the item, and user-generated content.

### BACKGROUND

User reviews of items provide important feedback to consumers. Examples of commonly reviewed items include consumer goods, services, places, and websites. However, those reviews are limited to the overall item such as a hotel or a store. Because of the large amount of review information, a user would have to search in the review comments for a specific aspect related to the reviewed item. For example, reviews of hotels generally provide overall comments related to the hotel. A user would have to search in the review comments for keywords such as “room 101” or “pool” to find comments related to those particular items.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 illustrates a granular rating system in accordance with one example embodiment.

FIG. 3 illustrates an example of a granular tree structure in accordance with one example embodiment.

FIG. 4 illustrates another example of a granular tree structure in accordance with one example embodiment.

FIG. 5 illustrates a flow diagram of a method for a granular item system in accordance with one example embodiment.

FIG. 6 illustrates a flow diagram of a method for storing reviews, ratings, and a classifier selection of a dish in accordance with one example embodiment.

FIG. 7 illustrates a flow diagram of a method for performing a search query of a granular item in accordance with one example embodiment.

FIG. 8 illustrates a screenshot in accordance with one example embodiment.

FIG. 9 illustrates a screenshot in accordance with one example embodiment.

FIG. 10 illustrates a screenshot in accordance with one example embodiment.

FIG. 11 illustrates a screenshot in accordance with one example embodiment.

FIG. 12 illustrates a screenshot in accordance with one example embodiment.

FIG. 13 illustrates a screenshot in accordance with one example embodiment.

FIG. 14 illustrates a screenshot in accordance with one example embodiment.

FIG. 15 is block diagram showing a software architecture within which the present disclosure may be implemented, according to an example embodiment,

FIG. 16 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Reviews of commercial places such as restaurants or hotels provide general comments related to the place such as service or cleanliness. There is currently no mechanism to access a more granular level of reviews related to a dish of a restaurant, a specific room of a hotel, or a component or accessory of a product (e.g., remote control of a television screen). Typically, a user of a review web site would have to perform a search in the general review comments using specific keywords such as for example: “spaghetti” of italian restaurant nearby, “room 101” of a particular hotel, or “pool” of hotels in a city.

The present application describes a system for identifying the granular items of an item, generate granular item attributes for the item, store values for the granular item attributes. For example, the system enables a user to identify a specific dish at a particular restaurant, rate the dish, write a review for the dish (and not necessarily the restaurant), and select classifiers related to the dish (e.g., gluten-free, lactose-free). The system stores the attribute values related to the granular item (e.g., a dish of a restaurant, or a reception area of a hotel). As such, the user can perform a search query on the granular items independently from the item itself. For example, the user can search ratings for spaghetti dishes within a distance radius without having to specify a particular Italian restaurant.

In one example, the granular items are based on a tree structure that is predefined by the system. In another example, the tree structure is constructed based on user feedback (e.g., crowd-sourced). For example, a user can generate a granular item attribute for a new dish of a restaurant.

In another example, the system identifies the item based on a location of a mobile device of the user. For example, the system identifies the restaurant name based on the location of the mobile device. In another example, the system identifies the granular item based on a user selection of a menu corresponding to the restaurant name. In another example, the system identifies the granular item based on a picture/image of the dish taken by the user at the restaurant. Those of ordinary skills in the art will recognize that the identification of the dish may be performed based on visual object recognition using machine learning (e.g., machine learning model). In another example, the system identifies the granular item based on a picture of a restaurant receipt taken by the user at the restaurant.

In another example, the system identifies a hotel name based on the location of the mobile device. In another example, the system identifies the granular item (e.g., reception area, business center, gym) based on a user selection of a predefined menu corresponding to the hotel name. In another example, the system identifies the granular item based on a location of the mobile device or picture from the mobile device. For example, the system determines that the granular item is a pool based on a picture of a pool taken by the user. In another example, the system determines that the granular item is a pool based on a location of the mobile device determined based on wife signals at the hotel.

In one example embodiment, a system for providing a granular rating of an item is described. The system identifies an item stored in a data structure. The system identifies a granular item of the item based on a tree structure of the item in the data structure. The system identifies an attribute of the granular item. The system receives a value of the attribute of the granular item and stores the value of the attribute of the granular item in the tree structure of the item in the data structure.

As a result, one or more of the methodologies described herein facilitate solving the technical problem of searching for particular items in a search query and the lack of granularity of the item. As such, one or more of the methodologies described herein may obviate a need for certain efforts or computing resources that otherwise would be involved in searching for keywords in a vast library of reviews that may be not relevant to a particular query. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

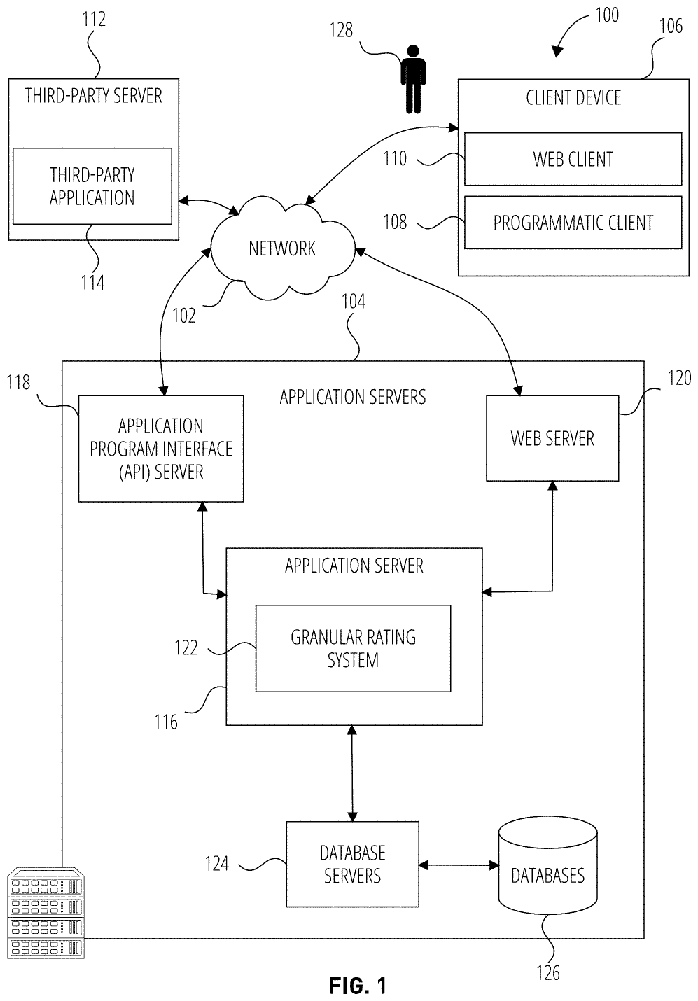

FIG. 1 is a diagrammatic representation of a network environment 100 in which some example embodiments of the present disclosure may be implemented or deployed.

One or more application servers 104 provide server-side functionality via a network 102 to a networked user device, in the form of a client device 110. A web client 110 (e.g., a browser) and a programmatic client 108 (e.g., an “app”) are hosted and execute on the web client 110.

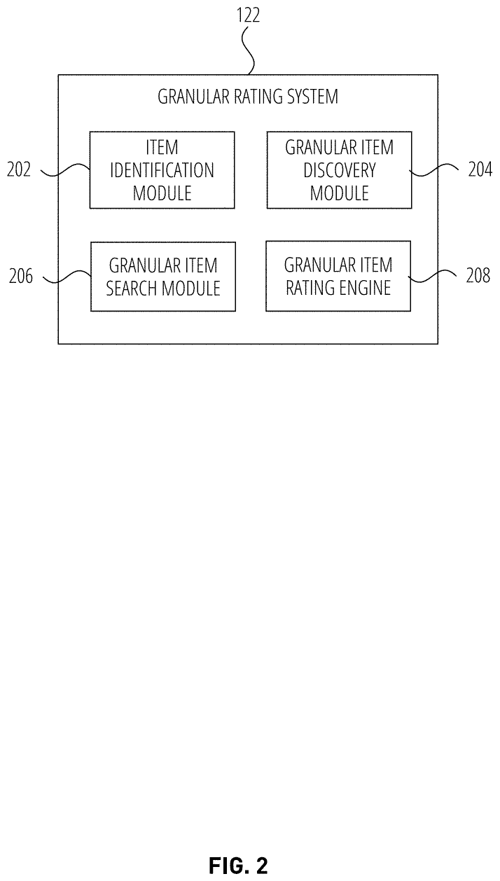

An Application Program Interface (API) server 118 and a web server 120 provide respective programmatic and web interfaces to application servers 104. A specific application server 116 hosts a granular rating system 122, which includes components, modules and/or applications. The granular rating system 122 is described further below with respect to FIG. 2.

The web client 110 communicates with the Granular rating system 122 via the web interface supported by the web server 120. Similarly, the programmatic client 108 communicates with the Granular rating system 122 via the programmatic interface provided by the Application Program Interface (API) server 118. The third-party application 114 may, for example, be another review website.

The application server 116 is shown to be communicatively coupled to database servers 124 that facilitates access to an information storage repository or databases 126. In an example embodiment, the databases 126 includes storage devices that store information to be published and/or processed by the Granular rating system 122.

Additionally, a third-party application 114 executing on a third-party server 112, is shown as having programmatic access to the application server 116 via the programmatic interface provided by the Application Program Interface (API) server 118. For example, the third-party application 114, using information retrieved from the application server 116, may supports one or more features or functions on a website hosted by the third party.

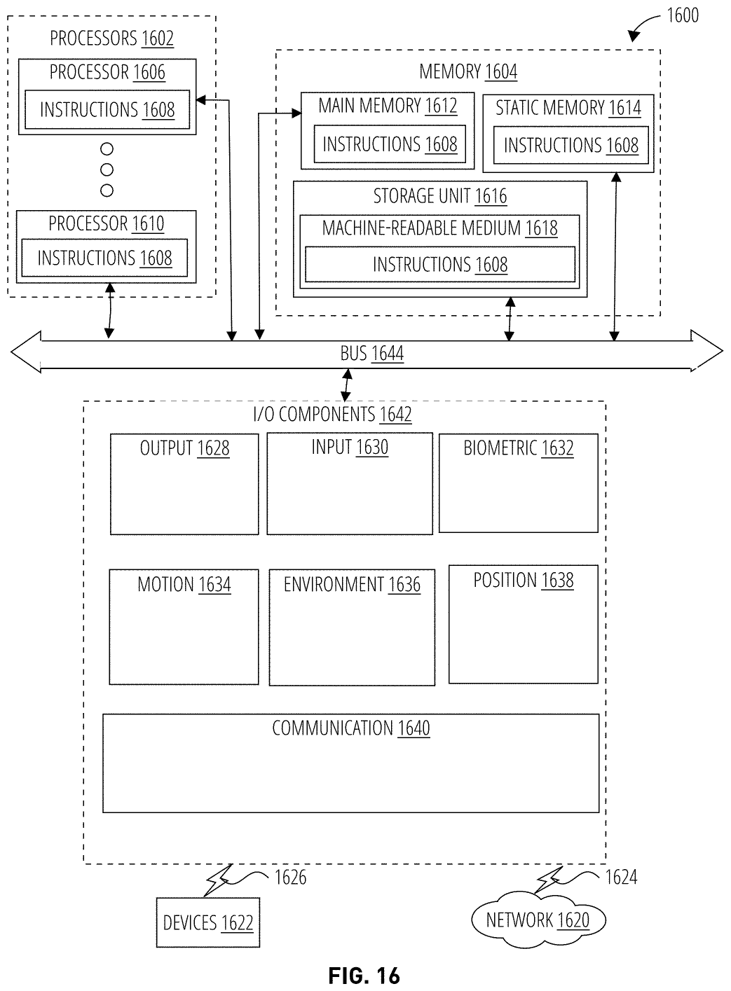

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 16, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 106 may be embodied within the network environment 100. Furthermore, some components or functions of the network environment 100 may be combined or located elsewhere in the network environment 100. For example, some of the functions of the client device 106 may be embodied at the application server 116.

FIG. 2 illustrates a granular rating system 122 in accordance with one example embodiment. The system comprises an item identification module 202, granular item discovery module 204, a granular item search module 206, and granular item rating engine 208.

The item identification module 202 identifies the item based on a geographic location of the mobile device (e.g., client device 106) of the user 128. In another example, the user 128 identifies the item (e.g., restaurant name) on the mobile device. In another example, the item identification module 202 receives an image of the item from the client device 106 and identifies the based on the image of the item using computer vision (e.g., applying a trained machine learning model to identify the item in the image; the machine learning model may be trained using pictures from a same geographic location or pictures from other location with similar attributes (e.g., all Chinese restaurants). In another example, the item identification module 202 identifies the item based on a combination of the image and the geographic location of the client device 106 (e.g., is the image associated with the geographic location?).

The granular item discovery module 204 retrieves granular items associated with the item identified by the item identification module 202. For example, the granular item search module 206 retrieves a menu corresponding a restaurant identified by the item identification module 202. The menu includes a list of dishes served at the restaurant. In another example, the user can define a new granular item (e.g., a new dish) for the restaurant using the granular item discovery module 204. In one example, embodiment, the granular item discovery module 204 uses the image of the item and the geographic location data to identify the granular item associated with the item. For example, the granular item discovery module 204 identifies a vegetarian dish (granular item) based on a picture of spagetthi with only sauce (no meat) at a particular geographic location (e.g., restaurant x at geographic location). In another example, the granular item discovery module 204 identifies that the item is a cocktail drink based on a picture of the cocktail. In a further example, the granular item discovery module 204 identifies that the cocktail drink is a margarita cocktail based on a shape and color of the drink. In other examples, the granular item discovery module 204 makes use of other inputs to identify the granular item. Other inputs can include sound (e.g., crowd in a bar), text in the image (e.g., signs or distinguishable text above a bar, a poster in a room), objects associated with the granular item (e.g., a coaster of a cocktail drink).

In another example, the granular item discovery module 204 identifies attributes of the granular items: dish name, dish rating, dish review, dish classifier (e.g., gluten-free). The granular item discovery module 204 receives values for the attributes from the user and stores the values for the granular item. Other examples of attributes include cleanliness, comfort, ambience, space, health precautions (personal protection equipment such as face masks and hand sanitizers), and so forth.

The granular item search module 206 enables a user to perform a query for a granular item based on the name of the granular item (e.g., dish name, cocktail name) and/or location of the user 128. For example, the granular item search module 206 enables the user to query for California rolls within a geographic area/region (e.g., zip code). In another example, the granular item search module 206 enables a user to search for margarita cocktails within a 5 mile radius of the mobile device of the user.

The granular item rating engine 208 generates a rating for the granular item based on the dish rating attribute values provided by users of the granular rating system 122. For example, the user may assign a rating on a scale of 1 to 5 to specific dish, a cocktail, or another attribute of the granular item (e.g., saltiness of a dish).

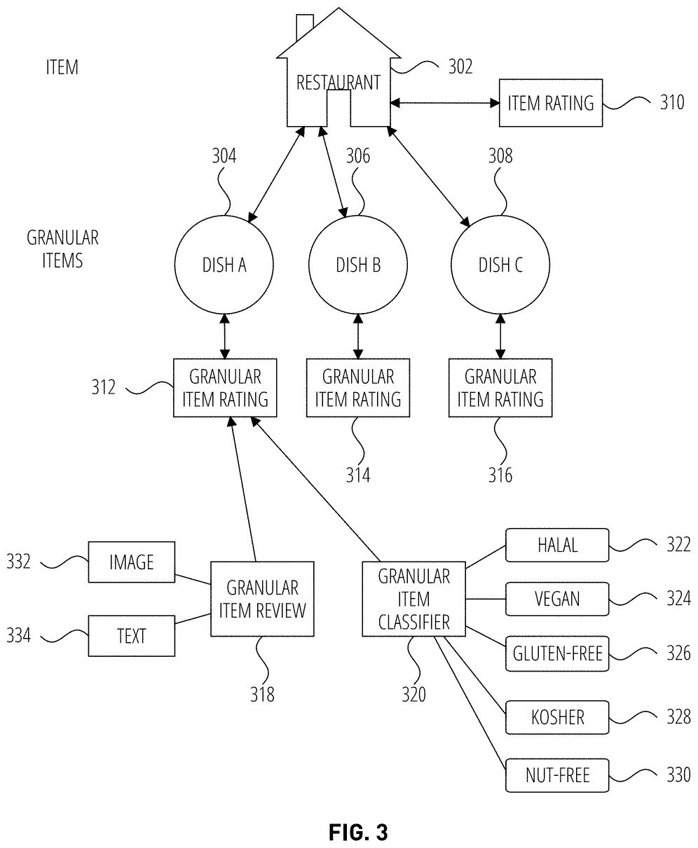

FIG. 3 illustrates an example of a granular tree structure in accordance with one example embodiment. The item may be a restaurant 302. The restaurant 302 is associated with an item rating 310 (e.g., 5 star restaurant). In one example, the user 128 is located at the restaurant 302 and takes a picture of a dish. The granular item discovery module 204 identifies the granular items based on the picture of the dish (e.g., dish A 304, dish B 306, dish C 308). Each granular item is associated with a corresponding granular item rating (granular item attribute). For example, the granular item rating 312 is an attribute of dish A 304. The granular item rating 314 is an attribute of dish B 306. The granular item rating 316 is an attribute of dish C 308.

Other attributes include a granular item review 318 and a granular item classifier 320. For example, the granular item review 318 can include reviews consisting of image 332 and text 334. The granular item classifier 320 can assign the dish A 304 with further attributes: halal 322, vegan 324, gluten-free 326, kosher 328, and nut-free 330.

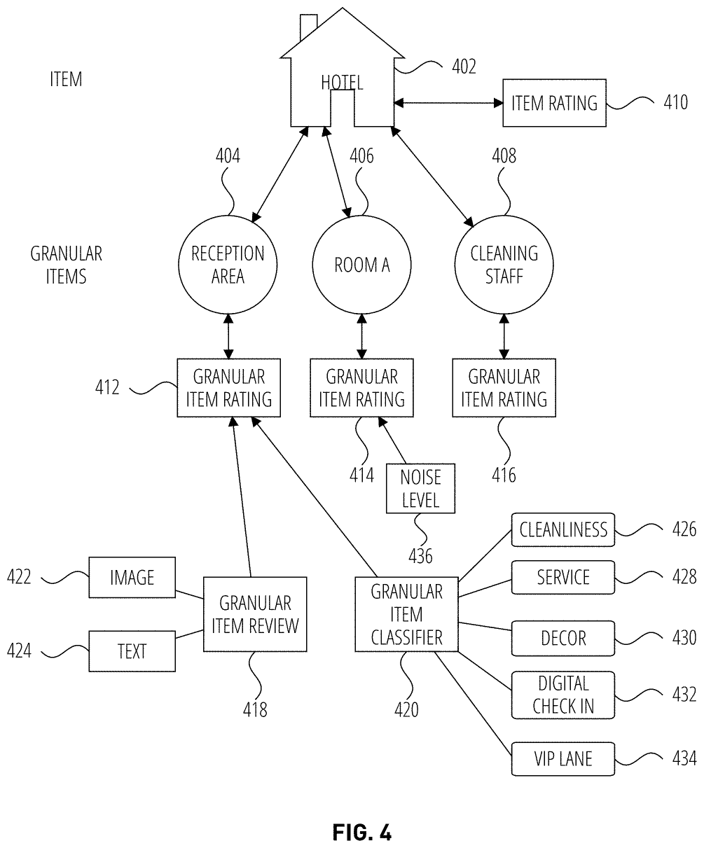

FIG. 4 illustrates another example of a granular tree structure in accordance with one example embodiment. The item may be a hotel 402. The hotel 402 is associated with an item rating 410 (e.g., 5 star hotel). In one example, the user 128 is located at the hotel 402 and takes a picture (e.g., a reception area 404, room A 406). The granular item discovery module 204 identifies the granular items based on the pictures. In another example, the granular item discovery module 204 identifies a cleaning staff 408 as a granular item because the mobile device of the user is located at the hotel 402. Each granular item is associated with a corresponding granular item rating (granular item attribute). For example, the granular item rating 412 is an attribute of reception area 404. The granular item rating 414 is an attribute of room A 406. An example of an attribute of granular item rating 414 includes a noise level 436. The granular item rating 416 is an attribute of cleaning staff 408.

An example attribute of the granular item rating 412 includes granular item review 418 and granular item classifier 420. For example, the granular item review 418 can include reviews consisting of image 422 and text 424. The granular item classifier 420 can assign the reception area 404 with further attributes: cleanliness 426, service 428, decor 430, digital check in 432, vip lane 434.

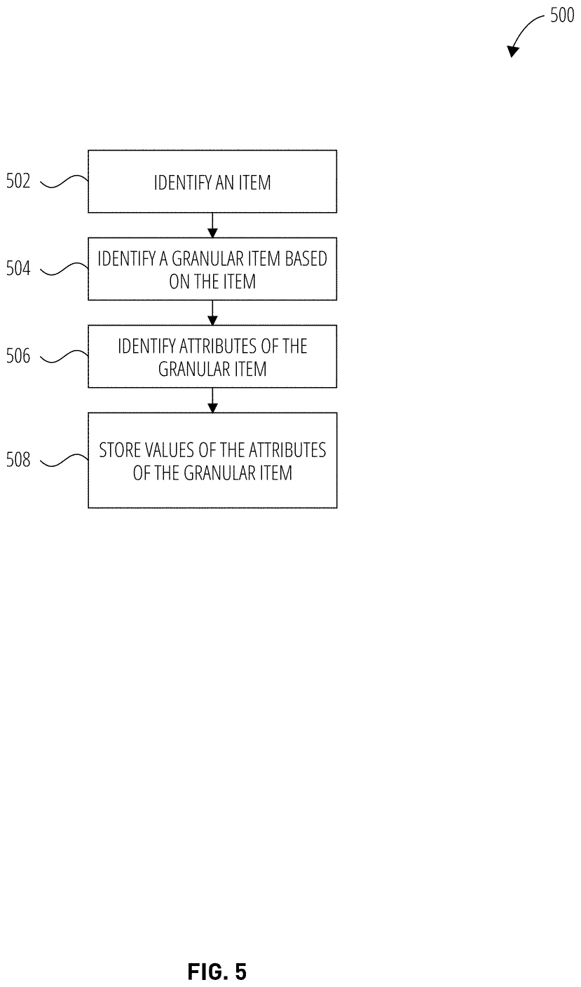

FIG. 5 is a flow diagram illustrating a method 500 for storing attribute values of granular items. The method 500 may be performed by one or more computational devices, as described below. Operations in the method 500 may be performed by the granular rating system 122, using components (e.g., modules, engines) described above with respect to FIG. 2. Accordingly, the method 500 is described by way of example with reference to the granular rating system 122. However, it shall be appreciated that at least some of the operations of the method 500 may be deployed on various other hardware configurations or be performed by similar Components residing elsewhere. For example, some of the operations may be performed at the third-party server 112.

At block 502, the granular rating system 122 identifies an item. In one example, the granular rating system 122 identifies the item based on a combination of a picture of the item and a geographic location of the mobile device.

At block 504, the granular rating system 122 identifies a granular item based on the item. For example, the granular rating system 122 identifies a type of dish (e.g., salads) based on the picture of the item (e.g., picture of the dish).

At block 506, the granular rating system 122 identifies attributes of the granular item. Examples of attributes of the salad dish include vegan, kosher, nut-free.

At block 508, the granular rating system 122 stores the values of the attributes of the granular item. For example, a value of “0” or “1” is assigned to each attribute: “0” for vegan means that the salad dish is not vegan.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

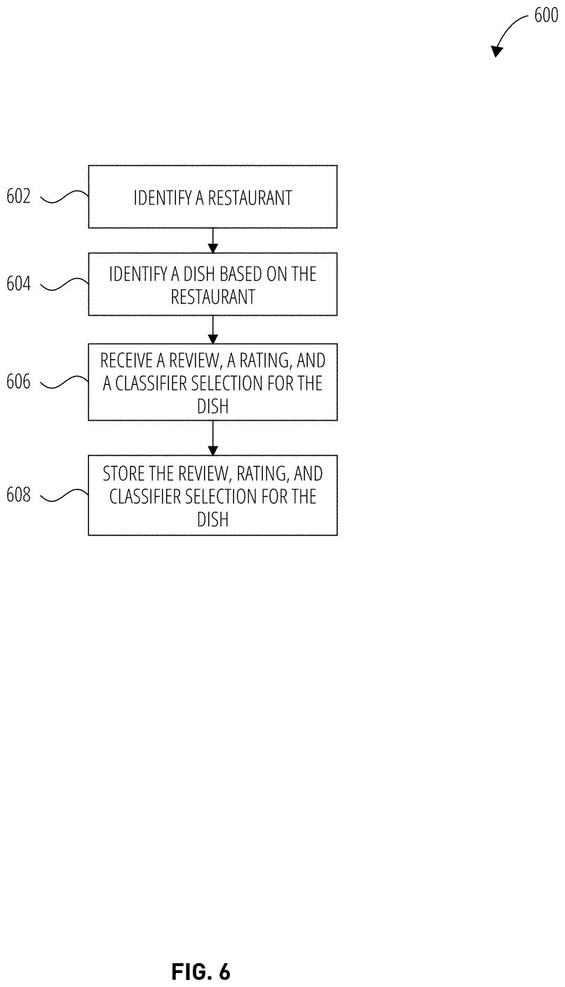

FIG. 6 is a flow diagram illustrating a method 600 for storing attribute values of granular items. The method 600 may be performed by one or more computational devices, as described below. Operations in the method 600 may be performed by the granular rating system 122, using components (e.g., modules, engines) described above with respect to FIG. 2. Accordingly, the method 600 is described by way of example with reference to the granular rating system 122. However, it shall be appreciated that at least some of the operations of the method 600 may be deployed on various other hardware configurations or be performed by similar Components residing elsewhere. For example, some of the operations may be performed at the third-party server 112.

At block 602, the granular rating system 122 identifies a restaurant. At block 604, the granular rating system 122 identifies a dish based on the restaurant. At block 606, the granular rating system 122 receives, from the user 128, a review, a rating, and a classifier selection for the dish. At block 608, the granular rating system 122 stores the review, a rating, and a classifier selection for the dish.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

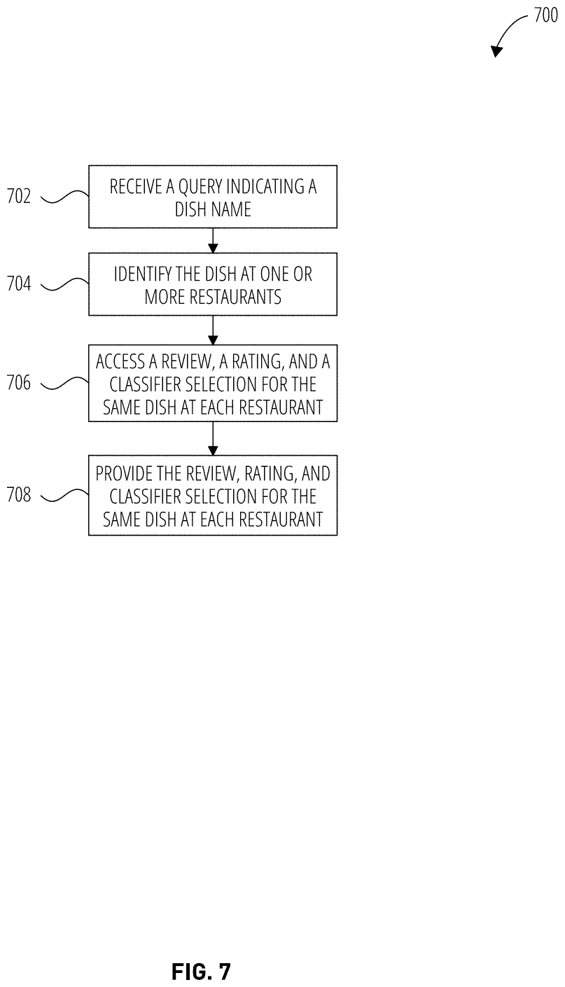

FIG. 7 is a flow diagram illustrating a method 700 for storing attribute values of granular items. The method 700 may be performed by one or more computational devices, as described below. Operations in the method 700 may be performed by the granular rating system 122, using components (e.g., modules, engines) described above with respect to FIG. 2. Accordingly, the method 700 is described by way of example with reference to the granular rating system 122. However, it shall be appreciated that at least some of the operations of the method 700 may be deployed on various other hardware configurations or be performed by similar Components residing elsewhere. For example, some of the operations may be performed at the third-party server 112.

At block 702, the granular rating system 122 receives a query indicating a dish name. At block 704, the granular rating system 122 identifies the dish at one or more restaurants within a geographic area. At block 706, the granular rating system 122 accesses a review, rating, and classifier selection for the same dish at each restaurant within the geographic area. At block 708, the granular rating system 122 provides the review, rating, and classifier selection for the same dish at each restaurant.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

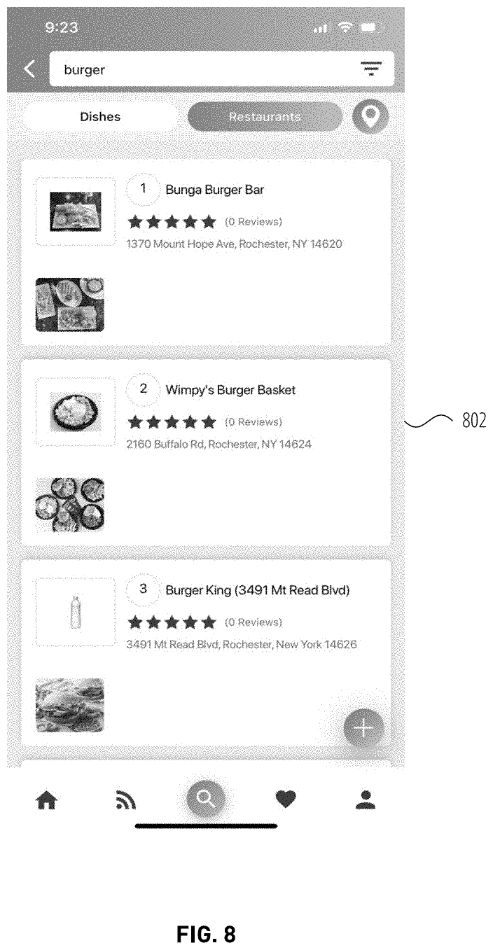

FIG. 8 illustrates a screenshot 802 in accordance with one example embodiment.

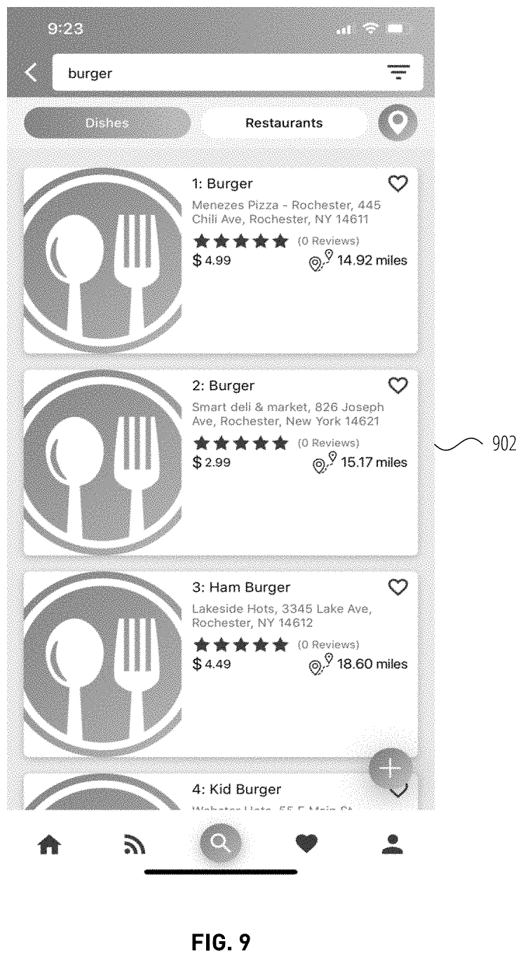

FIG. 9 illustrates a screenshot 902 in accordance with one example embodiment.

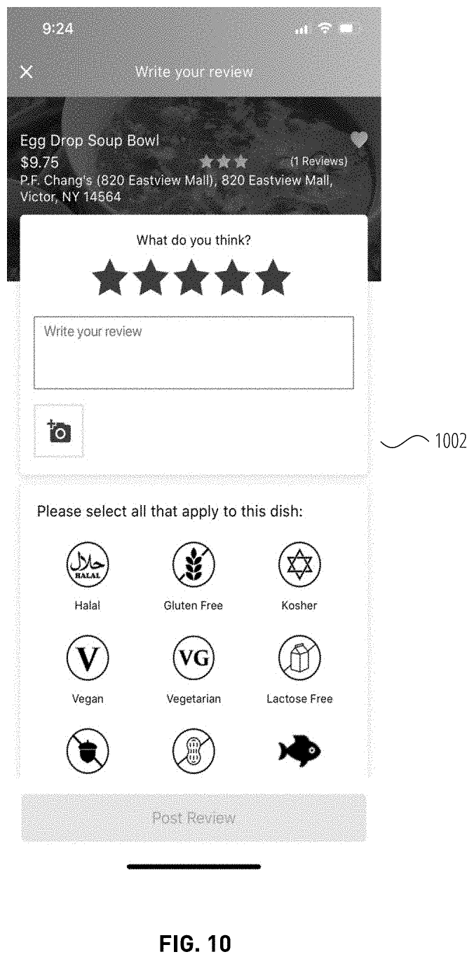

FIG. 10 illustrates a screenshot 1002 in accordance with one example embodiment.

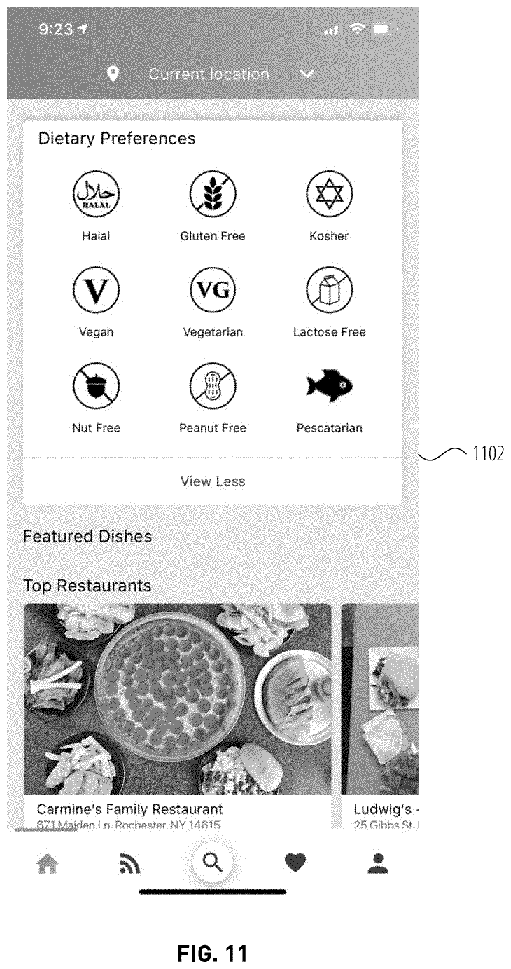

FIG. 11 illustrates a screenshot 1102 in accordance with one example embodiment.

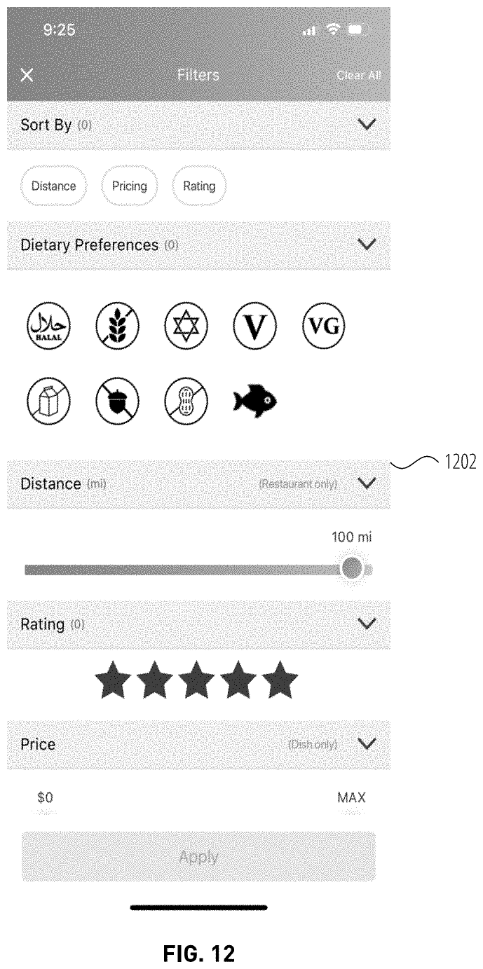

FIG. 12 illustrates a screenshot 1202 in accordance with one example embodiment.

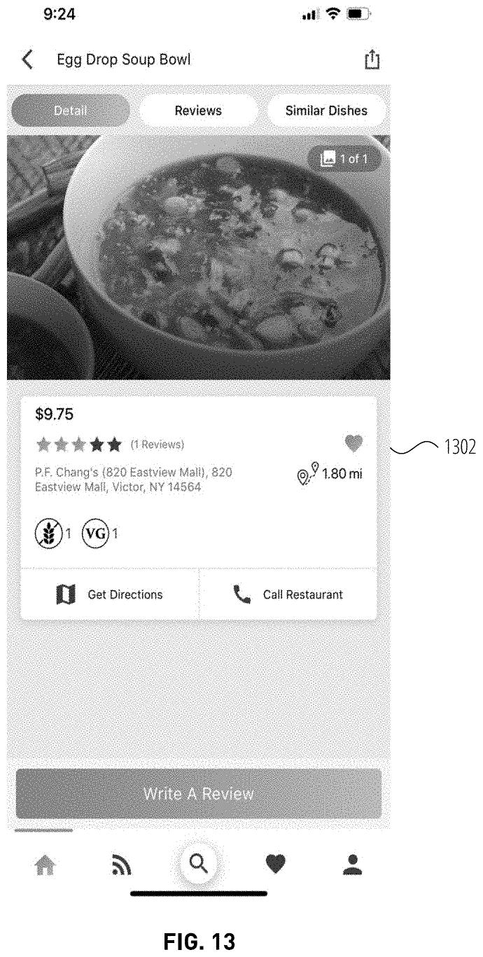

FIG. 13 illustrates a screenshot 1302 in accordance with one example embodiment.

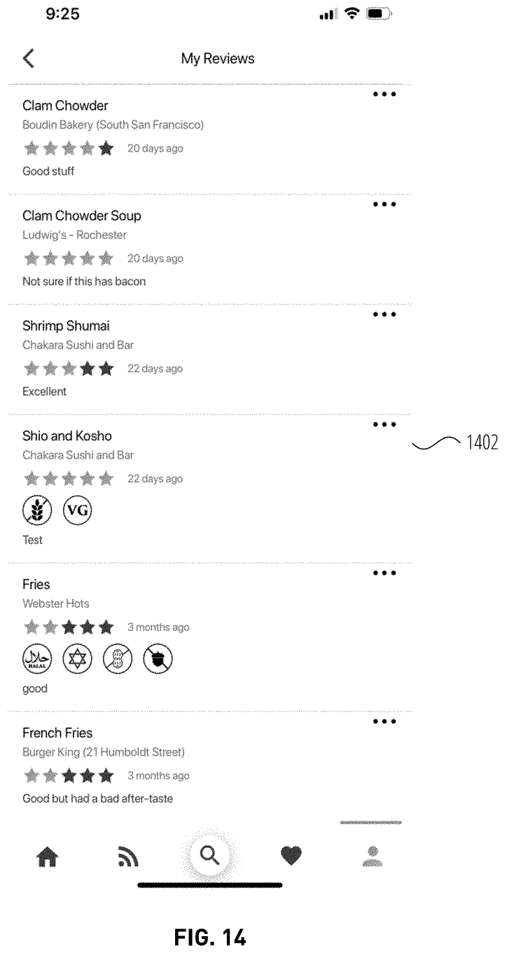

FIG. 14 illustrates a screenshot 1402 in accordance with one example embodiment.

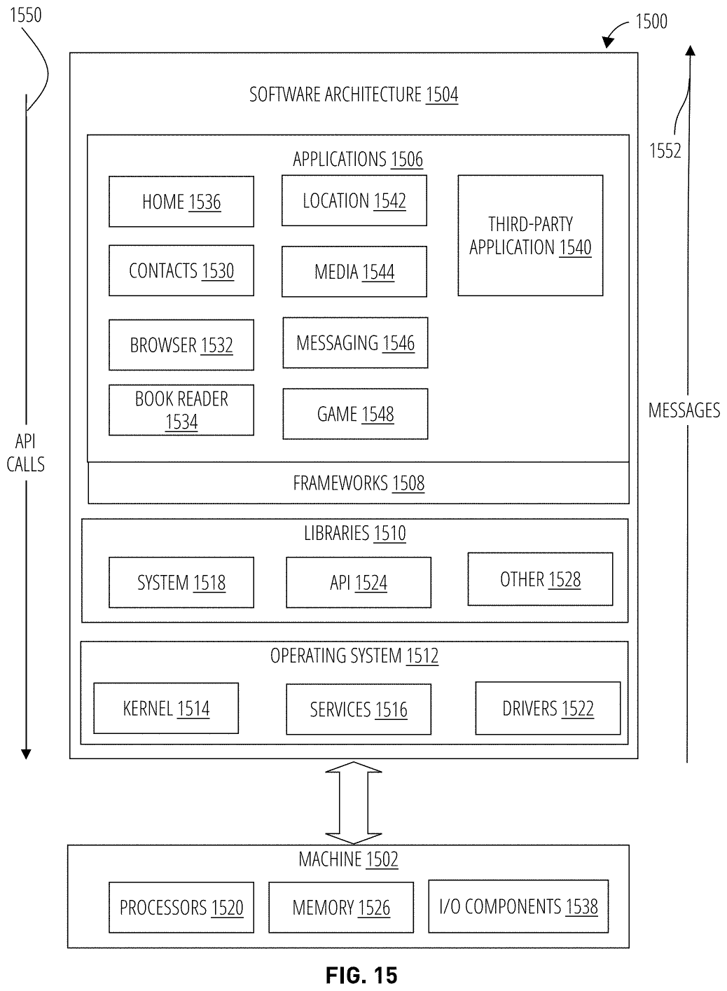

FIG. 15 is a block diagram 1500 illustrating a software architecture 1504, which can be installed on any one or more of the devices described herein. The software architecture 1504 is supported by hardware such as a machine 1502 that includes processors 1520, memory 1526, and I/O components 1538. In this example, the software architecture 1504 can be conceptualized as a stack of layers, where each layer provides a particular functionality. The software architecture 1504 includes layers such as an operating system 1512, libraries 1510, frameworks 1508, and applications 1506. Operationally, the applications 1506 invoke API calls 1550 through the software stack and receive messages 1552 in response to the API calls 1550.

The operating system 1512 manages hardware resources and provides common services. The operating system 1512 includes, for example, a kernel 1514, services 1516, and drivers 1522. The kernel 1514 acts as an abstraction layer between the hardware and the other software layers. For example, the kernel 1514 provides memory management, processor management (e.g., scheduling), component management, networking, and security settings, among other functionality. The services 1516 can provide other common services for the other software layers. The drivers 1522 are responsible for controlling or interfacing with the underlying hardware. For instance, the drivers 1522 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1510 provide a low-level common infrastructure used by the applications 1506. The libraries 1510 can include system libraries 1518 (e.g., C standard library) that provide functions such as memory allocation functions, string manipulation functions, mathematic functions, and the like. In addition, the libraries 1510 can include API libraries 1524 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1510 can also include a wide variety of other libraries 1528 to provide many other APIs to the applications 1506.

The frameworks 1508 provide a high-level common infrastructure that is used by the applications 1506. For example, the frameworks 1508 provide various graphical user interface (GUI) functions, high-level resource management, and high-level location services. The frameworks 1508 can provide a broad spectrum of other APIs that can be used by the applications 1506, some of which may be specific to a particular operating system or platform.

In an example embodiment, the applications 1506 may include a home application 1536, a contacts application 1530, a browser application 1532, a book reader application 1534, a location application 1542, a media application 1544, a messaging application 1546, a game application 1548, and a broad assortment of other applications such as a third-party application 1540. The applications 1506 are programs that execute functions defined in the programs. Various programming languages can be employed to create one or more of the applications 1506, structured in a variety of manners, such as object-oriented programming languages (e.g., Objective-C, Java, or C++) or procedural programming languages (e.g., C or assembly language). In a specific example, the third-party application 1540 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1540 can invoke the API calls 1550 provided by the operating system 1512 to facilitate functionality described herein.

FIG. 16 is a diagrammatic representation of the machine 1600 within which instructions 1608 (e.g., software, a program, an application, an applet, an app, or other executable code) for causing the machine 1600 to perform any one or more of the methodologies discussed herein may be executed. For example, the instructions 1608 may cause the machine 1600 to execute any one or more of the methods described herein. The instructions 1608 transform the general, non-programmed machine 1600 into a particular machine 1600 programmed to carry out the described and illustrated functions in the manner described. The machine 1600 may operate as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1608, sequentially or otherwise, that specify actions to be taken by the machine 1600. Further, while only a single machine 1600 is illustrated, the term “machine” shall also be taken to include a collection of machines that individually or jointly execute the instructions 1608 to perform any one or more of the methodologies discussed herein.

The machine 1600 may include processors 1602, memory 1604, and I/O components 1642, which may be configured to communicate with each other via a bus 1644. In an example embodiment, the processors 1602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1606 and a processor 1610 that execute the instructions 1608. The term “processor” is intended to include multi-core processors that may comprise two or more independent processors (sometimes referred to as “cores”) that may execute instructions contemporaneously. Although FIG. 16 shows multiple processors 1602, the machine 1600 may include a single processor with a single core, a single processor with multiple cores (e.g., a multi-core processor), multiple processors with a single core, multiple processors with multiples cores, or any combination thereof.

The memory 1604 includes a main memory 1612, a static memory 1614, and a storage unit 1616, both accessible to the processors 1602 via the bus 1644. The main memory 1604, the static memory 1614, and storage unit 1616 store the instructions 1608 embodying any one or more of the methodologies or functions described herein. The instructions 1608 may also reside, completely or partially, within the main memory 1612, within the static memory 1614, within machine-readable medium 1618 within the storage unit 1616, within at least one of the processors 1602 (e.g., within the processor's cache memory), or any suitable combination thereof, during execution thereof by the machine 1600.

The I/O components 1642 may include a wide variety of components to receive input, provide output, produce output, transmit information, exchange information, capture measurements, and so on. The specific I/O components 1642 that are included in a particular machine will depend on the type of machine. For example, portable machines such as mobile phones may include a touch input device or other such input mechanisms, while a headless server machine will likely not include such a touch input device. It will be appreciated that the I/O components 1642 may include many other components that are not shown in FIG. 16. In various example embodiments, the I/O components 1642 may include output components 1628 and input components 1630. The output components 1628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1642 may include biometric components 1632, motion components 1634, environmental components 1636, or position components 1638, among a wide array of other components. For example, the biometric components 1632 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1634 include acceleration sensor components (e.g., accelerometer), gravitation sensor components, rotation sensor components (e.g., gyroscope), and so forth. The environmental components 1636 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1638 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1642 further include communication components 1640 operable to couple the machine 1600 to a network 1620 or devices 1622 via a coupling 1624 and a coupling 1626, respectively. For example, the communication components 1640 may include a network interface component or another suitable device to interface with the network 1620. In further examples, the communication components 1640 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 1622 may be another machine or any of a wide variety of peripheral devices (e.g., a peripheral device coupled via a USB).

Moreover, the communication components 1640 may detect identifiers or include components operable to detect identifiers. For example, the communication components 1640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1640, such as location via Internet Protocol (IP) geolocation, location via Wi-Fi® signal triangulation, location via detecting an NFC beacon signal that may indicate a particular location, and so forth.

The various memories (e.g., memory 1604, main memory 1612, static memory 1614, and/or memory of the processors 1602) and/or storage unit 1616 may store one or more sets of instructions and data structures (e.g., software) embodying or used by any one or more of the methodologies or functions described herein. These instructions (e.g., the instructions 1608), when executed by processors 1602, cause various operations to implement the disclosed embodiments.

The instructions 1608 may be transmitted or received over the network 1620, using a transmission medium, via a network interface device (e.g., a network interface component included in the communication components 1640) and using any one of a number of well-known transfer protocols (e.g., hypertext transfer protocol (HTTP)). Similarly, the instructions 1608 may be transmitted or received using a transmission medium via the coupling 1626 (e.g., a peer-to-peer coupling) to the devices 1622.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### EXAMPLES

Example 1 is a computer-implemented method comprising: receiving an image generated from a client device and location data from the client device; identifying an item stored in a data structure based on the image and the location data; identifying a granular item of the item based on a tree structure of the item in the data structure; identifying an attribute of the granular item; receiving a value of the attribute of the granular item; and storing the value of the attribute of the granular item in the tree structure of the item in the data structure.

Example 2 includes the method of example 1, wherein the attribute comprises a granular item name attribute, a rating attribute, a review attribute, a classifier selection attribute, a location attribute, wherein the tree structure is formed based on crowd-sourced user entries of granular item definitions.

Example 3 includes the method of example 2, further comprising: receiving a query indicating a keyword and a geographic area; and identifying a first granular item based on the keyword and the geographic area.

Example 4 includes the method of example 3, further comprising: applying a machine learning model to the image to identify the granular item based an identification of the item, wherein the granular item name attribute of the first granular item includes the keyword, wherein the location attribute indicates that the first granular item is located within the geographic area.

Example 5 includes the method of example 1, wherein the item indicates a restaurant, wherein the granular item indicates a dish of the restaurant.

Example 6 includes the method of example 1, wherein the item indicates a hotel, wherein the granular item indicates an area of the hotel.

Example 7 includes the method of example 1, wherein the item indicates a physical item, wherein the granular item indicates a component of the physical item.

Example 8 is a computing apparatus comprising: a processor; and a memory storing instructions that, when executed by the processor, configure the apparatus to: receive an image generated from a client device and location data corresponding to the image from the client device; identify an item stored in a data structure based on the image and the location data; identify a granular item of the item based on a tree structure of the item in the data structure; identify an attribute of the granular item; receive a value of the attribute of the granular item; and store the value of the attribute of the granular item in the tree structure of the item in the data structure.

Example 9 includes the computing apparatus of example 8, wherein the attribute comprises a granular item name attribute, a rating attribute, a review attribute, a classifier selection attribute, a location attribute, wherein the tree structure is formed based on crowd-sourced user entries of granular item definitions.

Example 10 includes the computing apparatus of example 9, wherein the instructions further configure the apparatus to: receive a query indicating a keyword and a geographic area; and identify a first granular item based on the keyword and the geographic area.

Example 11 includes the computing apparatus of example 10, wherein the apparatus is further configured to apply a machine learning model to the image to identify the granular item based an identification of the item, wherein the granular item name attribute of the first granular item includes the keyword, wherein the location attribute indicates that the first granular item is located within the geographic area. wherein the granular item name attribute of the first granular item includes the keyword, wherein the location attribute indicates that the first granular item is located within the geographic area.

Example 12 includes the computing apparatus of example 8, wherein the item indicates a restaurant, wherein the granular item indicates a dish of the restaurant.

Example 13 includes the computing apparatus of example 8, wherein the item indicates a hotel, wherein the granular item indicates an area of the hotel.

Example 14 includes the computing apparatus of example 8, wherein the item indicates a physical item, wherein the granular item indicates a component of the physical item.

Example 15 is a non-transitory computer-readable storage medium, the computer-readable storage medium including instructions that when executed by a computer, cause the computer to: receive an image generated from a client device and location data corresponding to the image from the client device; identify an item stored in a data structure based on the image and the location data; identify a granular item of the item based on a tree structure of the item in the data structure; identify an attribute of the granular item; receive a value of the attribute of the granular item; and store the value of the attribute of the granular item in the tree structure of the item in the data structure.

Example 16 includes the computer-readable storage medium of example 15, wherein the attribute comprises a granular item name attribute, a rating attribute, a review attribute, a classifier selection attribute, a location attribute, wherein the tree structure is formed based on crowd-sourced user entries of granular item definitions.

Example 17 includes the computer-readable storage medium of example 16, wherein the instructions further configure the computer to: receive a query indicating a keyword and a geographic area; and identify a first granular item based on the keyword and the geographic area.

Example 18 includes the computer-readable storage medium of example 17, wherein the instructions further configure the computer to apply a machine learning model to the image to identify the granular item based an identification of the item, wherein the granular item name attribute of the first granular item includes the keyword, wherein the location attribute indicates that the first granular item is located within the geographic area. wherein the granular item name attribute of the first granular item includes the keyword, wherein the location attribute indicates that the first granular item is located within the geographic area.

Example 19 includes the computer-readable storage medium of example 15, wherein the item indicates a restaurant, wherein the granular item indicates a dish of the restaurant.

Example 20 includes the computer-readable storage medium of example 15, wherein the item indicates a hotel, wherein the granular item indicates an area of the hotel.

What is claimed is:

1. A computer-implemented method comprising:
receiving an image generated from a client device and location data from the client device;
identifying an item stored in a data structure based on the image and the location data;
identifying a granular item of the item based on a tree structure of the item in the data structure;
identifying an attribute of the granular item;
receiving a value of the attribute of the granular item; and
storing the value of the attribute of the granular item in the tree structure of the item in the data structure.

2. The computer-implemented method of claim 1, wherein the attribute comprises a granular item name attribute, a rating attribute, a review attribute, a classifier selection attribute, a location attribute,
wherein the tree structure is formed based on crowd-sourced user entries of granular item definitions.

3. The computer-implemented method of claim 2, further comprising:
receiving a query indicating a keyword and a geographic area; and
identifying a first granular item based on the keyword and the geographic area.

4. The computer-implemented method of claim 3, further comprising:
applying a machine learning model to the image to identify the granular item based an identification of the item,
wherein the granular item name attribute of the first granular item includes the keyword, wherein the location attribute indicates that the first granular item is located within the geographic area.

5. The computer-implemented method of claim 1, wherein the item indicates a restaurant, wherein the granular item indicates a dish of the restaurant.

6. The computer-implemented method of claim 1, wherein the item indicates a hotel, wherein the granular item indicates an area of the hotel.

7. The computer-implemented method of claim 1, wherein the item indicates a physical item, wherein the granular item indicates a component of the physical item.

8. A computing apparatus comprising:
a processor; and
a memory storing instructions that, when executed by the processor, configure the apparatus to:
receive an image generated from a client device and location data corresponding to the image from the client device;
identify an item stored in a data structure based on the image and the location data;
identify a granular item of the item based on a tree structure of the item in the data structure;
identify an attribute of the granular item;
receive a value of the attribute of the granular item; and
store the value of the attribute of the granular item in the tree structure of the item in the data structure.

9. The computing apparatus of claim 8, wherein the attribute comprises a granular item name attribute, a rating attribute, a review attribute, a classifier selection attribute, a location attribute, wherein the tree structure is formed based on crowd-sourced user entries of granular item definitions.

10. The computing apparatus of claim 9, wherein the instructions further configure the apparatus to:
receive a query indicating a keyword and a geographic area; and
identify a first granular item based on the keyword and the geographic area.

11. The computing apparatus of claim 10, wherein the apparatus is further configured to apply a machine learning model to the image to identify the granular item based an identification of the item,
wherein the granular item name attribute of the first granular item includes the keyword, wherein the location attribute indicates that the first granular item is located within the geographic area.

12. The computing apparatus of claim 8, wherein the item indicates a restaurant, wherein the granular item indicates a dish of the restaurant.

13. The computing apparatus of claim 8, wherein the item indicates a hotel, wherein the granular item indicates an area of the hotel.

14. The computing apparatus of claim 8, wherein the item indicates a physical item, wherein the granular item indicates a component of the physical item.

15. A non-transitory computer-readable storage medium, the computer-readable storage medium including instructions that when executed by a computer, cause the computer to:
receive an image generated from a client device and location data corresponding to the image from the client device;
identify an item stored in a data structure based on the image and the location data;
identify a granular item of the item based on a tree structure of the item in the data structure;
identify an attribute of the granular item;
receive a value of the attribute of the granular item; and
store the value of the attribute of the granular item in the tree structure of the item in the data structure.

16. The computer-readable storage medium of claim 15, wherein the attribute comprises a granular item name attribute, a rating attribute, a review attribute, a classifier selection attribute, a location attribute,
wherein the tree structure is formed based on crowd-sourced user entries of granular item definitions.

17. The computer-readable storage medium of claim 16, wherein the instructions further configure the computer to:
receive a query indicating a keyword and a geographic area; and
identify a first granular item based on the keyword and the geographic area.

18. The computer-readable storage medium of claim 17, wherein the instructions further configure the computer to apply a machine learning model to the image to identify the granular item based an identification of the item,
wherein the granular item name attribute of the first granular item includes the keyword, wherein the location attribute indicates that the first granular item is located within the geographic area.

19. The computer-readable storage medium of claim 15, wherein the item indicates a restaurant, wherein the granular item indicates a dish of the restaurant.

20. The computer-readable storage medium of claim 15, wherein the item indicates a hotel, wherein the granular item indicates an area of the hotel.
